(19) United States
(12) Patent Application Publication
(10) Pub. No.: US 2008/0191063 A1
(43) Pub. Date: Aug. 14, 2008

(54) Fuel Injection Device for an Internal Combustion Engine

(76) Inventors: Peter Boehland, Marbach (DE); Godehard Nentwig, Stuttgart (DE); Michael Bauer, Gerlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/565,800

(22) PCT Filed: Jun. 9, 2004
(86) PCT No.: PCT/DE04/01202

§ 371 Date: Jan. 25, 2006

(30) Foreign Application Priority Data
Jul. 26, 2003 (DE) 103 34 209.5

(51) Int. Cl. F02M 61/04

(52) U.S. Cl. 239/533.3

(57) ABSTRACT

The invention relates to a fuel injection device for an internal combustion engine having a housing, a first valve element, which has a first hydraulic control surface acting in the closing direction at least one second valve element, which has a second hydraulic control surface acting in the closing direction. Each valve element is associated with its own hydraulic control chamber, which can be connected to a shared high-pressure connection and is at least partially delimited by a respective hydraulic control surface. There is a fluid connection between the control chambers. The fuel injection device includes a valve device that can disconnect the fluid connection.

### PRIOR ART

The invention relates to a fuel injection device for an internal combustion engine, having a housing and a first valve element, which has a first hydraulic control surface that acts in the closing direction, and having at least one second valve element, which has a hydraulic control surface that acts in the closing direction; each valve element is associated with its own hydraulic control chamber, which can be connected to a shared high-pressure connection and is at least partially delimited by a respective hydraulic control surface, and there is a fluid connection between the control chambers.

A fuel injection device of this kind is known from DE 101 22 241 A1. It is used in internal combustion engines with direct fuel injection. In engines of this kind, each combustion chamber is associated with its own fuel injection device that injects the fuel into the respective combustion chamber at a high pressure.

Particularly in diesel engines, in order to reduce emissions and increase the efficiency of the engine, it is desirable to inject the fuel into the combustion chamber of the engine in as finely atomized a spray as possible. In order to achieve this goal, the injection pressure at which the fuel is supplied to the fuel injection device can, for example, be comparatively high.

If there are a comparatively large number of outlet conduits, then the fuel pressure would have to be significantly reduced in order to also be able to inject small amounts without excessively curtailing the corresponding injection times. But since this would result in a reduced quality of fuel atomization, it is instead preferable to use fuel injection devices that have several valve elements, each of which is associated with certain outlet conduits. If only a small amount of fuel is to be injected, then only one valve element opens so that the fuel is injected into the combustion chamber through only a small number of outlet conduits. This permits small quantities to be introduced into the combustion chamber with good atomization even at a high pressure.

In the known device, both valve elements are stroke-controlled. Each valve element therein is associated with a hydraulic control surface acting in the closing direction and a hydraulic pressure surface acting in the opening direction. If the valve element is to open, the pressure acting on the control surface is reduced.

The object of the present invention is to modify a fuel injection device of the type mentioned at the beginning so that it injects the fuel in an optimal fashion in all load ranges of the internal combustion engine.

This object is attained in a fuel injection device of the type mentioned at the beginning by virtue of the fact that it has a valve device that is able to shut off the fluid connection.

### ADVANTAGES OF THE INVENTION

Because it is possible to shut off the fluid connection, the one valve element can be hydraulically decoupled from the other valve element. Primarily, this makes it possible to prevent the valve element, which opens second and would close again with even a slight pressure increase, from closing prematurely, which would result in an undesirably flat injection pressure curve at the end of an injection. This would be detrimental to the metering of the fuel into the combustion chamber and would complicate the task of supplying the required fuel quantity, particularly at full load.

Advantageous modifications of the invention are disclosed in the dependent claims.

According to a first embodiment, at least two valve elements are situated coaxially, the control chamber associated with the inner valve element and the fluid connection are situated in an end section of the outer valve element, and the valve device has a pin-shaped, preferably conical valve member on the inner valve element, which, in an open end position of the inner valve element, at least approximately closes the mouth of the fluid connection into the inner control chamber. A fuel injection device of this type is compact and reliable. In addition, when the inner valve is open, its effective control surface is reduced, which helps to prevent a premature closing.

It is particularly advantageous if the hydraulic control surface of the inner valve element is conical as a whole and thus constitutes the valve member of the valve device. This simplifies manufacture.

If the end segment of the outer valve element has a separate cylindrical part containing a central, stepped through bore, this simplifies production.

It is alternatively conceivable for the fluid connection to extend approximately in the radial direction and for the valve device to have a valve edge on a valve element functioning as a slide valve, which, in an open end position of this valve element, at least approximately covers the mouth of the fluid connection. This makes it possible to achieve tighter production tolerances.

According to another embodiment of the invention, the fluid connection has a flow throttle. In this instance, the hydraulic coupling of the pressure curve in the one control chamber can be very precisely adjusted to the pressure curve in the other control chamber.

The fact that one valve element has a driving segment which rests against the other valve element at least at the beginning of the closing process assures a joint closing action in certain operating situations. This promotes the achievement of an injection behavior that is favorable from an emissions standpoint.

It is particularly advantageous if the control surfaces are dimensioned so that when the pressure in the control chamber associated with the outer valve element is increased further, before the inner valve element has moved into its open end position in which it closes the fluid connection, the inner valve element closes before the outer valve element and it is also particularly advantageous if the hydraulic force, which acts on the effective control surface of the inner valve element when the valve device is closed and when the maximum pressure prevails in the control chamber associated with the outer valve element, is sufficient to move the inner valve element in the closing direction as soon as the outer valve element has reached its closed position. In this case, a successive opening and closing of the two valve elements can be implemented during partial load, whereas a successive opening but a virtually simultaneous closing of the valve elements is possible during full load.

### DRAWINGS

Particularly preferred exemplary embodiments of the present invention are explained in detail below in conjunction with the accompanying drawings.

FIG. 1 schematically represents a fuel system of an internal combustion engine with a number of fuel injection devices;

FIG. 2 shows a partial section through one of the fuel injection devices from FIG. 1;

FIG. 3 shows a detail III of the fuel injection device from FIG. 2;

FIG. 4 shows a detail IV of the fuel injection device from FIG. 2 in a first operating state;

FIG. 5 shows a depiction similar to FIG. 4 in a second operating state;

FIG. 6 shows a graph in which the strokes of the two valve elements and the switched position of an on-off valve at a partial load of the internal combustion engine are plotted over time;

FIG. 7 shows a graph similar to FIG. 6 at full load;

FIG. 8 shows a graph in which the delivered fuel quantity is plotted over a triggering time of the fuel injection device shown in FIGS. 1 through 5;

FIG. 9 shows a depiction similar to FIG. 3 of a modified embodiment form of a fuel injection device; and

FIG. 10 shows a depiction similar to FIG. 3 of a further modified embodiment form of a fuel injection device.

### DESCRIPTION OF THE EXEMPLARY EMBODIMENTS

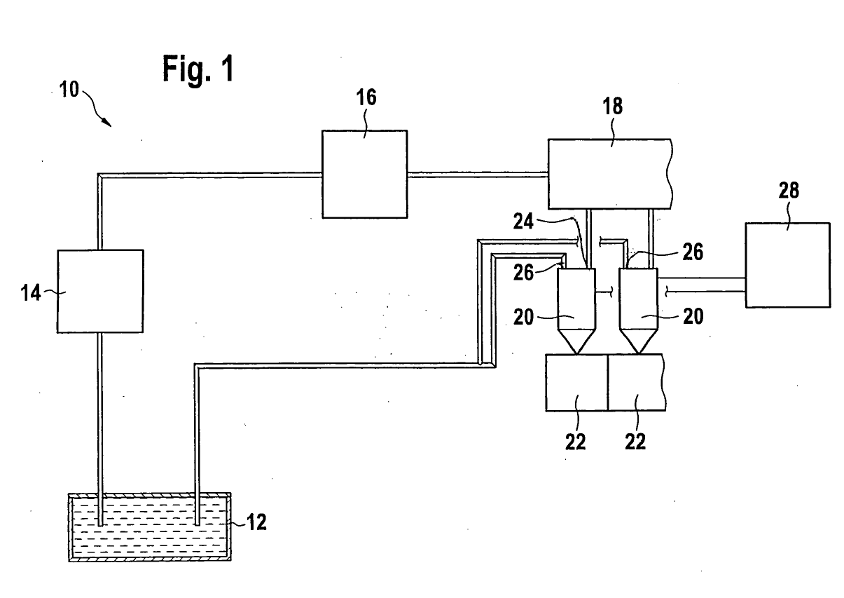

In FIG. 1, a fuel system as a whole is labeled with the reference numeral 10. It is associated with an internal combustion engine that is not shown in detail. The fuel system 10 has a fuel tank 12 from which an electrical fuel pump 14 delivers the fuel to a high-pressure fuel pump 16, which compresses the fuel to a very high pressure and supplies it to a fuel accumulator 18 (“rail”).

A number of fuel injection devices 20 are connected to the fuel accumulator 18. Each of them injects the fuel directly into a combustion chamber 22 respectively associated with it. The fuel injection devices 20 are each connected to the fuel accumulator 18 by means of a respective high-pressure connection 24 and the fuel injection devices 20 are each connected to the fuel tank 12 via a respective low-pressure connection 26. A control and regulating unit 28 controls and regulates the operation of the fuel injection devices 20.

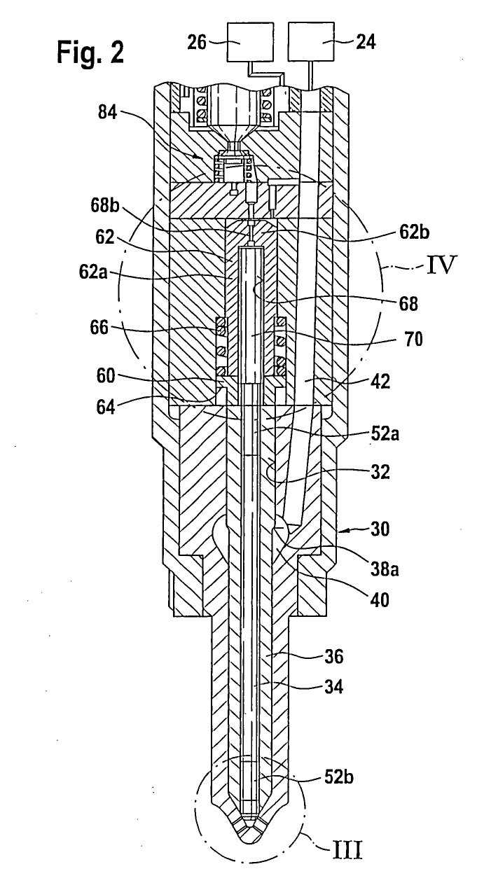

The precise embodiment of the fuel injection devices 20 will now be explained with particular reference to FIGS. 2 through 5:

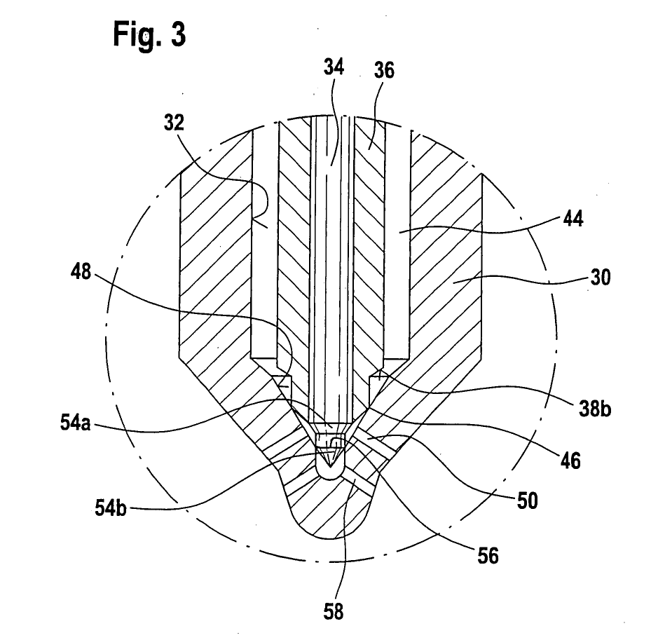

A multipart housing 30 contains a recess 32 extending in the longitudinal direction. This recess contains two valve elements 34 and 36 that are situated coaxial to each other. At approximately the height of the halfway point of its longitudinal span, the outer valve element 36 has a hydraulic pressure surface 38a that acts in the opening direction and is embodied in the form of a conical circumferential shoulder. In this region, the recess 32 has a pressure chamber 40 comprised of a circumferential expansion. This pressure chamber is connected via a high-pressure conduit 42 to the high-pressure connection 24. In the region of its end at the bottom in FIG. 2, the outer valve element 36 has a second pressure surface 38b that acts in the opening direction and is embodied in the form of a conical shoulder (see FIG. 3).

An annular chamber 44 extends from the pressure chamber 40 to the pressure surface 38b. Downstream of the pressure surface 38b, the outer valve element 36 also has a sealing edge 46 that rests against a conical housing surface 48 of the recess 32 when the valve element 36 is closed. Downstream of the sealing edge 46, the housing 30 has a number of fuel outlet conduits 50 passing through it, evenly distributed in the circumference direction.

The inner valve element 34 has two guide segments 52a and 52b with which it is guided inside the outer valve element 36. At the end toward the bottom in FIGS. 2 and 3, the inner valve element 34 has a first pressure surface 54a that acts in the opening direction and is embodied in the form of a conical shoulder. Downstream of this, is a sealing edge 56 that likewise rests against the conical housing surface 48 when the inner valve element 34 is closed. The tip of the inner valve element 34 comprises another pressure surface 54b that acts in the opening direction of the valve element 34. The inner valve element 34 is associated with fuel outlet conduits 58 that are likewise distributed over the circumference of the housing 30.

The outer valve element 36 has a separate intermediate segment 60 and a separate, sleeve-shaped end cap 62. The intermediate segment 60 has a radially extending collar 64 that supports a compression spring 66. The compression spring 66 acts on the outer valve element 36 in the closing direction. The end cap 62 is embodied as a cylindrical part with a side wall 62a and a top 62b that contains a central, stepped through bore 68. An end piston 70 of the inner valve element 34 is guided in a sliding fashion in a region 68a of the through bore with a comparatively large diameter, which is situated toward the bottom in FIGS. 2, 4, and 5.

A region 68b of the through bore 68 has a comparatively small diameter and connects a hydraulic chamber 72, which is situated between the end piston 70 of the inner valve element 34 and the end cap 62 of the outer valve element 36, to a hydraulic chamber 74, which is situated between the end cap 62 and the housing 30, and is referred to below as the connecting conduit 68b. The control chamber 74 is continuously connected to the high-pressure conduit 42 via a high-pressure conduit 76 and an inlet throttle 78 associated with it.

At the end oriented toward the end piston 70, the control chamber 72 is delimited by a hydraulic control surface 73, which has an outer, flat edge section 73a and a central, conical, perpendicularly protruding pin section 73b. At the end oriented toward the end cap 62 of the outer valve element 36, the control chamber 74 is analogously delimited by a hydraulic control surface 75 that has a flat, central section 75a and a beveled edge section 75b. The mouth (unnumbered) of the connecting conduit 68b into the inner control chamber 72 constitutes of valve seat for the pin section 73b. This forms a valve device 77 that can close the connecting conduit 68b. This will be discussed in greater detail further below.

An outlet throttle 80 and an outlet conduit 82 lead from the control chamber 74 to an electromagnetic on-off valve 84 whose other connection leads to the low-pressure connection 26. The on-off valve 84 can connect the control chamber 74 to the low-pressure connection 26 or disconnect it from the low-pressure connection 26. The mouth of the outlet throttle 80 into the control chamber 74 is situated coaxial to the connecting conduit 68b in the end cap 62 of the outer valve element 36. The mouth of the high-pressure conduit 76, however, is situated in the vicinity of the outer edge of the control chamber 74.

The fuel injection device 20 shown in FIGS. 2 through 5 functions as follows:

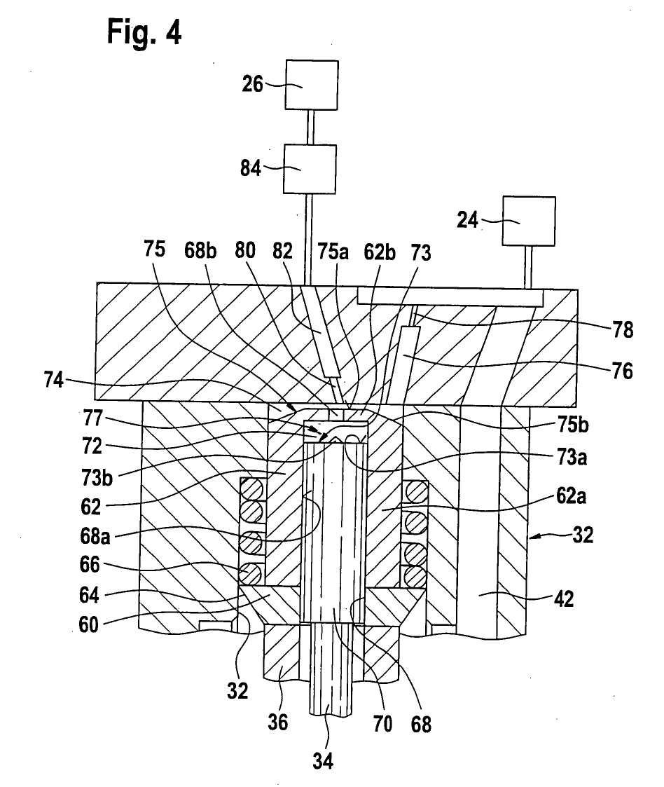

In the starting position shown in FIG. 4, on the one hand, the on-off valve 84 is closed and on the other hand, the valve elements 34 and 36 are also closed. The control chambers 72 and 74 are therefore disconnected from the low-pressure connection 26 and only connected to the high-pressure connection 24. In the two control chambers 72 and 74, therefore, the maximum possible fluid pressure prevails, which approximately corresponds to the pressure at the high-pressure connection 24 and in the fuel accumulator 18. The same pressure also prevails in the high-pressure conduit 42, in the pressure chamber 40, and in the annular chamber 44 and consequently also acts on the pressure surfaces 38a and 38b of the outer valve element 36.

The size of the control surface 75 on the end cap 62 of the outer valve element 36, the force of the compression spring 66, and the dimensions of the two pressure surfaces 38a and 38b are matched to one another so that when the maximum possible fuel pressure prevails in the control chamber 74, the force resultant acting on the outer valve element 36 reliably presses the sealing edge 46 of this outer valve element 36 against the conical housing surface 48. As a result, no fuel can escape from either the outlet conduits 50 or the outlet conduits 58. In this initial state, the sealing edge 56 of the inner valve element 34 also rests against the conical housing surface 48, primarily due to the hydraulic force acting on the control surface 73 on the end piston 70 of the inner valve element 34.

If a comparatively small quantity of fuel is to be injected into a combustion chamber 22 by the fuel injection device 20, then the on-off valve 84 is opened for only a short time. This reduces the pressure in the control chamber 74 and correspondingly also reduces the hydraulic force acting on the control surface 75. But since the high fluid pressure is still acting on both of the pressure surfaces 38a and 38b of the outer valve element 36, the forces acting in the opening direction now prevail. The sealing edge 46 is therefore lifted away from the conical housing surface 48 and the outer valve element 36 opens. Consequently, fuel can flow to the outlet conduits 50 and out through them.

The pressure drop in the control chamber 72, which is associated with the inner valve element 34, is delayed in comparison to the pressure drop in the control chamber 74 because the connecting conduit 68b in the end cap 62 of the outer valve element 36 constitutes an additional throttle restriction. If the on-off valve 84 is closed punctually, then the pressure drop in the control chamber 72, which is associated with the inner valve element 34, is stopped before the inner valve element 34 opens.

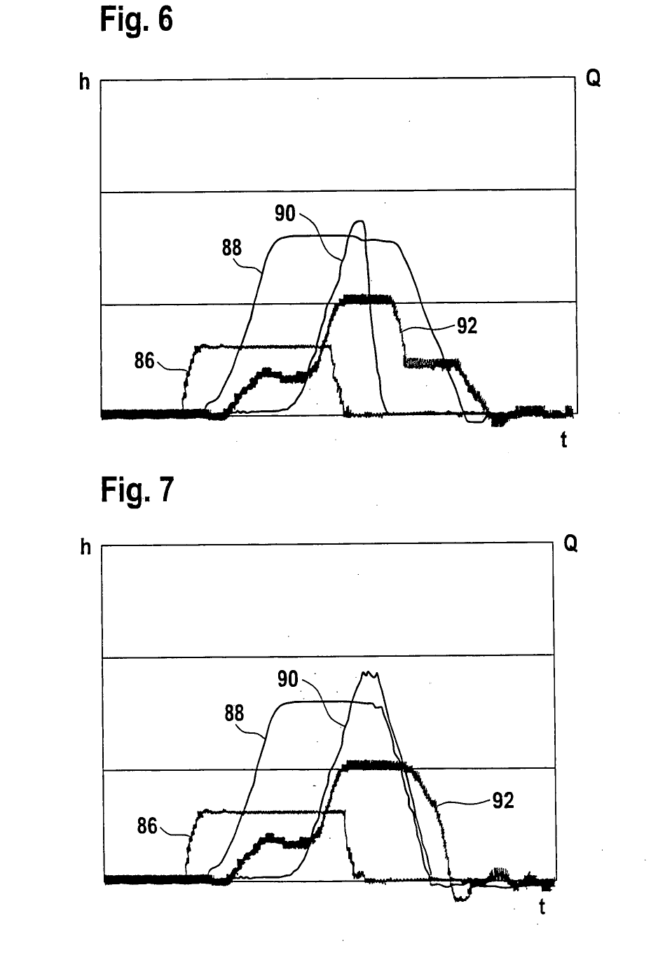

If the inner valve element 34 is also to open, then the on-off valve 84 is opened for correspondingly longer time. The first case to be considered here is the one in which only a medium quantity of fuel is to be injected, for example during partial load operation of the internal combustion engine. This case is plotted over time t in FIG. 6. The curve that represents the switched position of the on-off valve 84 is labeled with the reference numeral 86. The stroke curve h of the outer valve element 36 is labeled 88 and that of the inner valve element is labeled 90. The curve that represents the fuel flow dQ/dt is labeled with the reference numeral 92.

The opening process of the outer valve element 36 is identical to the one described above. However, the on-off valve 84 is now left open until the pressure in the control chamber 72 can also fall to the point that the hydraulic force acting on the pressure surface 54a of the end or valve element 34 in the opening direction exceeds the hydraulic force acting on the control surface 73 in the closing direction. As a result, the sealing edge 56 of the inner valve element 34 lifts away from the housing surface 48 so that fuel also travels to the outlet conduits 58 and exits the fuel injection device 20 through them. The diameter of the connecting conduit 68b is selected so that the fuel can only flow out of the control chamber 72 at a comparatively slow pace. The inner valve element 34 therefore opens at correspondingly slow pace by and large.

The on-off valve 84 in the example discussed here is closed again before the valve pin 73b of the inner valve element 34 comes into contact with the top 62b of the end cap 62 and closes the connecting conduit 68b. Consequently the pressure in the control chamber 74, which is associated with the outer valve element 36, does in fact rise at first. But the connecting conduit 68b also transmits the pressure increase to the inner control chamber 72. Since its volume is comparatively small and the control surface 73 is comparatively large, the inner valve element 34 begins its closing motion (curve 90) before the outer valve element 36 (curve 88). If the on-off valve 84 is closed before the inner valve element 34 has reached its open end position, then this inner valve element closes before the outer valve element. A stepped injection behavior (curve 92 in FIG. 6) occurs during the opening and closing.

If the on-off valve 84 is left open long enough for the inner valve element 34 to also open, then this does not lead to a sudden increase in the fuel quantity delivered by the fuel injection device 20, but rather to a gradual one. This avoids a so-called “quantity jump” in this triggering time boundary region of the on-off valve 84 in the fuel injection device 20 shown in FIGS. 2 through 5.

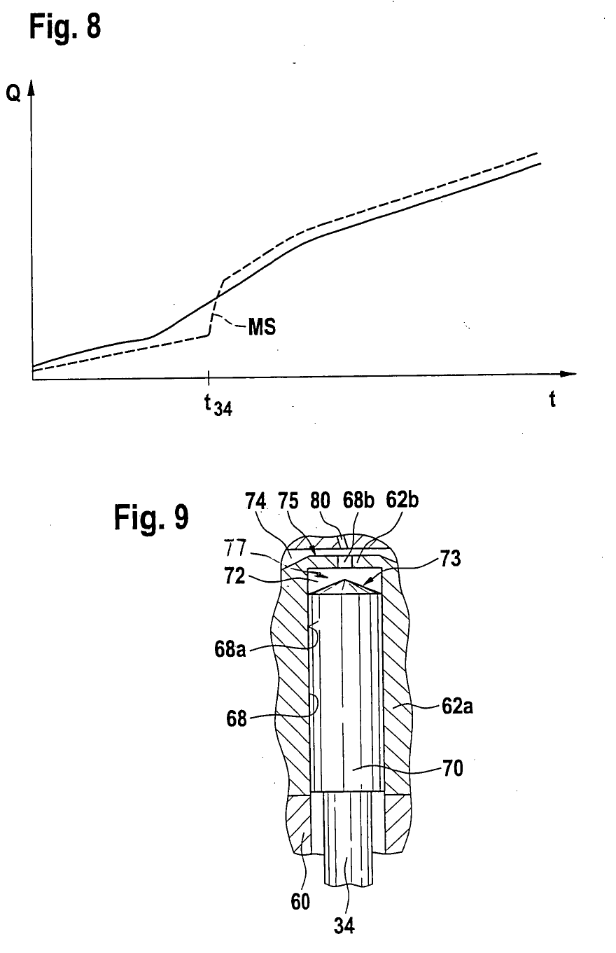

A corresponding curve, which represents the fuel quantity delivered over the triggering time of the on-off valve 84, is plotted in FIG. 8. The triggering duration of the on-off valve 84 at which the inner valve element 34 begins to open is labeled t₃₄. It is clear that even at time t₃₄, no abrupt increase can be observed in the fuel quantity Q delivered by the fuel injection device 20. The corresponding curve with a conventional fuel injection device 20 is shown with a dashed line in FIG. 6. It has a clearly evident quantity jump MS at time t₃₄.

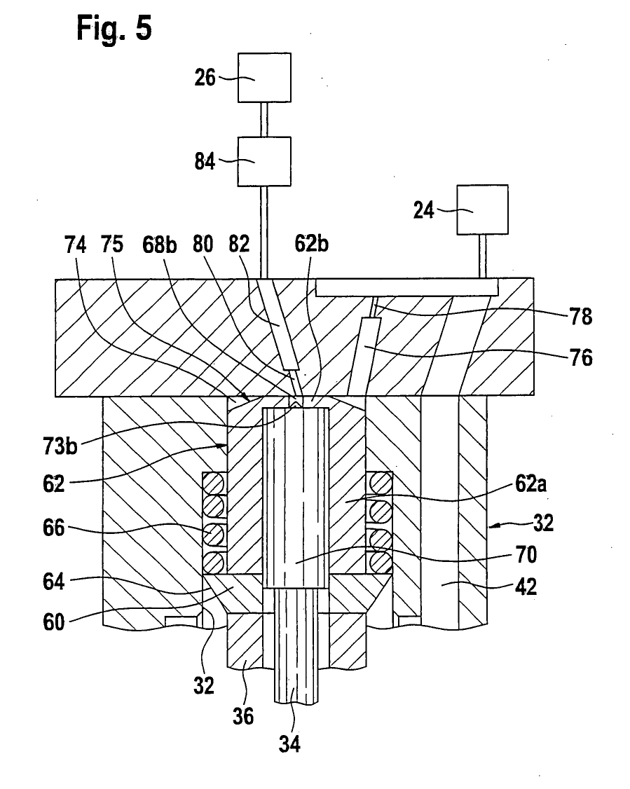

Now another practical application will be discussed of the type that occurs, for example, during full load operation of the internal combustion engine. This case is plotted in FIG. 7. The opening of the two valve elements 34 and 36 occurs as described above. However, the on-off valve 84 remains open until the inner valve element 34 can reach its open end position in which the valve pin 73b of the valve device 77 closes the connecting conduit 68b (see FIG. 5). This disconnects the control chamber 72 from the control chamber 74. The pressure in the control chamber 72 now falls further due to the leakage between the end piston 70 and the end cap 62 and in the extreme case, falls to the level of the low-pressure connection 26.

If the injection of fuel is to be terminated, then the on-off valve 84 is closed. This increases the pressure in the control chamber 74 and in the connecting conduit 68b. But in comparison to the pressure surfaces 54a and 54b of the inner valve element 34 acting in the opening direction, the effective surface area of the pin section 73b is small enough to assure that the inner valve element 34 does not automatically close at first. Instead, the inner valve element 34 is carried along by the pin section 73b resting against the top 62b during the closing motion of the outer valve element 36. The inner and outer valve elements 34 and 36 therefore close at the same time.

As soon as the sealing edge 46 of the outer valve element 36 comes into the immediate vicinity of the housing surface 48, the fuel flow to the outlet conduits 50 and the outlet conduits 58 is throttled. This also reduces the pressure acting on the pressure surfaces 54a and 54b of the inner valve element 34 and reduces the hydraulic force acting on the inner valve element 34 in the opening direction. Finally, the force acting on the pin section 73b in the closing direction prevails and is sufficient to move the end piston 70 of the inner valve element 34 away from the top 62b.

As a result, a correspondingly high fluid pressure acts more or less abruptly on the entire control surface 73 of the end piston 70 so that the inner valve element 34 is very rapidly moved the rest of the distance to its completely closed position. Only a very slight distance remains to be traveled because the outer valve element 36 has in fact already forced the inner valve element 34 to execute a considerable amount of closing stroke. The inner valve element 34 therefore closes at approximately the same time as the outer valve element 36. The fuel injection device 20 shown in FIGS. 2 through 5 is therefore able to dispense the fuel into the combustion chamber 22 with much greater precision.

FIG. 9 shows a region of an alternative embodiment form of a fuel injection device 20. Those elements and regions that have functions equivalent to elements and regions of the above-described exemplary embodiment are furnished with the same reference numerals and are not discussed in further detail. The difference lies in the embodiment of the control surface 73 on the end piston 70. In this case, it has no pin section, but is instead embodied as conical over its entire surface. This simplifies manufacture.

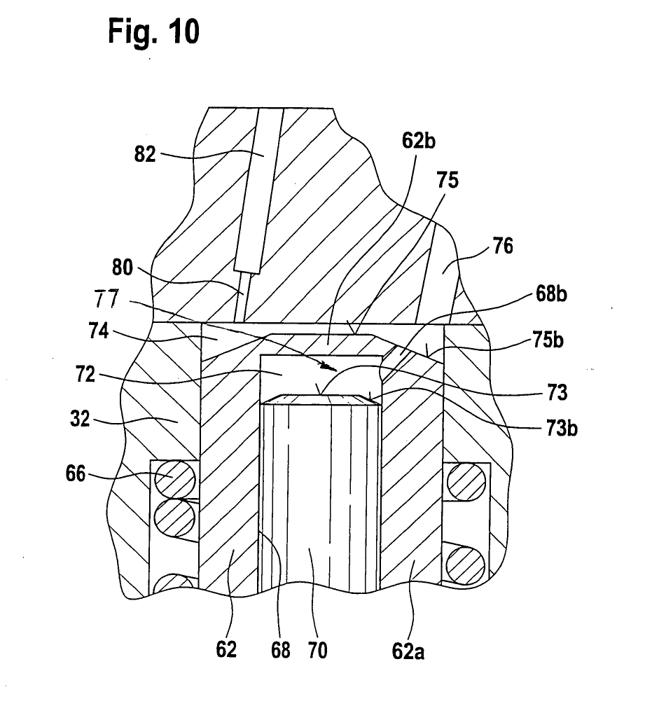

FIG. 10 shows another embodiment form. Here, too, those elements and regions that have functions equivalent to elements and regions of the above-described exemplary embodiment are furnished with the same reference numerals and are not discussed in further detail.

By contrast with the exemplary embodiments described above, the control surface 73 of the end piston 70 of the inner valve element 34 is embodied as flat, with a bevel 73b at its edge. In addition, the bore 68 is embodied as a blind bore. A fluid conduit 68b extends diagonally out and up from its edge region immediately adjacent to the top 62b and leads to the beveled edge section 75b of the control surface 75 on the end cap 62. Moreover, the outlet conduit 82 with the outlet throttle 80 does not lead into the control chamber 74 centrally, but rather into a region facing the beveled edge section 75b. In the exemplary embodiment shown in FIG. 8, the fluid conduit 68b and the radially outer edge of the bevel 73b constitute a slide valve 77 that can open or close the connection between the control chamber 72 and the control chamber 74.

1-8. (canceled)

9. A fuel injection device for an internal combustion engine, comprising
a housing and a first valve element which has a first hydraulic control surface acting in the closing direction
at least one second valve element which has a second hydraulic control surface acting in the closing direction,
said first and said at least one second valve elements each being associated with a separate hydraulic control chamber which control chambers are capable of being connected to a shared high-pressure connection and which are at least partially delimited by a respective hydraulic control surface
a fluid connection between the control chambers, and
a valve device in the fluid connection that is able to disconnect the fluid connection.

10. The fuel injection device according to claim 9, wherein said first and second valve elements are situated coaxially, wherein control chamber associated with the inner valve element and the fluid connection are situated in an end section of the outer valve element, and wherein the valve device has a pin-shaped, preferably conical valve member on the inner valve element, which, in an open end position of the inner valve element, at least approximately closes the mouth of the fluid connection into the inner control chamber.

11. The fuel injection device according to claim 10, wherein the hydraulic control surface of the inner valve element is conical as a whole and thus constitutes the valve member of the valve device.

12. The fuel injection device according to claim 10, wherein the end segment of the outer valve element comprises a separate cylindrical part containing a central, stepped through bore.

13. The fuel injection device according to claim 11, wherein the end segment of the outer valve element comprises a separate cylindrical part containing a central, stepped through bore.

14. The fuel injection device according to claim 9, wherein the fluid connection extends approximately in the radial direction and the valve device has a valve edge on a valve element functioning as a slide valve, which, in an open end position of this valve element, at least approximately covers the mouth of the fluid connection.

15. The fuel injection device according to claim 9, wherein the fluid connection comprises a flow throttle.

16. The fuel injection device according to claim 10, wherein the fluid connection comprises a flow throttle.

17. The fuel injection device according to claim 11, wherein the fluid connection comprises a flow throttle.

18. The fuel injection device according to claim 12, wherein the fluid connection comprises a flow throttle.

19. The fuel injection device according to claim 14, wherein the fluid connection comprises a flow throttle.

20. The fuel injection device according to claim 9, wherein one valve element comprises a driving segment that rests against the other valve element at least at the beginning of the closing process.

21. The fuel injection device according to claim 10, wherein one valve element comprises a driving segment that rests against the other valve element at least at the beginning of the closing process.

22. The fuel injection device according to claim 12, wherein one valve element comprises a driving segment that rests against the other valve element at least at the beginning of the closing process.

23. The fuel injection device according to claim 14, wherein one valve element comprises a driving segment that rests against the other valve element at least at the beginning of the closing process.

24. The fuel injection device according to claim 9, wherein the control surfaces are dimensioned so that when the pressure in the control chamber associated with the outer valve element is increased further, before the inner valve element has moved into its open end position in which it closes the fluid connection, the inner valve element closes before the outer valve element and the hydraulic force, which acts on the effective control surface of the inner valve element when the valve device is closed and when the maximum pressure prevails in the control chamber associated with the outer valve element, is sufficient to move the inner valve element in the closing direction as soon as the outer valve element has reached its closed position.

25. The fuel injection device according to claim 10, wherein the control surfaces are dimensioned so that when the pressure in the control chamber associated with the outer valve element is increased further, before the inner valve element has moved into its open end position in which it closes the fluid connection, the inner valve element closes before the outer valve element and the hydraulic force, which acts on the effective control surface of the inner valve element when the valve device is closed and when the maximum pressure prevails in the control chamber associated with the outer valve element, is sufficient to move the inner valve element in the closing direction as soon as the outer valve element has reached its closed position.

26. The fuel injection device according to claim 13, wherein the control surfaces are dimensioned so that when the pressure in the control chamber associated with the outer valve element is increased further, before the inner valve element has moved into its open end position in which it closes the fluid connection, the inner valve element closes before the outer valve element and the hydraulic force, which acts on the effective control surface of the inner valve element when the valve device is closed and when the maximum pressure prevails in the control chamber associated with the outer valve element, is sufficient to move the inner valve element in the closing direction as soon as the outer valve element has reached its closed position.

27. The fuel injection device according to claim 14, wherein the control surfaces are dimensioned so that when the pressure in the control chamber associated with the outer valve element is increased further, before the inner valve element has moved into its open end position in which it closes the fluid connection, the inner valve element closes before the outer valve element and the hydraulic force, which acts on the effective control surface of the inner valve element when the valve device is closed and when the maximum pressure prevails in the control chamber associated with the outer valve element, is sufficient to move the inner valve element in the closing direction as soon as the outer valve element has reached its closed position.

28. The fuel injection device according to claim 20, wherein the control surfaces are dimensioned so that when the pressure in the control chamber associated with the outer valve element is increased further, before the inner valve element has moved into its open end position in which it closes the fluid connection, the inner valve element closes before the outer valve element and the hydraulic force, which acts on the effective control surface of the inner valve element when the valve device is closed and when the maximum pressure prevails in the control chamber associated with the outer valve element, is sufficient to move the inner valve element in the closing direction as soon as the outer valve element has reached its closed position.
